(19) United States
(12) Patent Application Publication
(10) Pub. No.: US 2025/0278349 A1
(43) Pub. Date: Sep. 4, 2025

(54) METHODS, SYSTEMS, AND COMPUTER READABLE MEDIA FOR PROVIDING A TESTING AND VALIDATION PLATFORM FOR MACHINE LEARNING LIFECYCLE TESTING AND VALIDATION

(71) Applicant: Keysight Technologies, Inc., Santa Rosa, CA (US)

(72) Inventors: Lukas Klose, Braunschweig (DE); Carl Schiller, Hannover (DE)

(21) Appl. No.: 18/614,222

(22) Filed: Mar. 22, 2024

Related U.S. Application Data
(60) Provisional application No. 63/559,569, filed on Feb. 29, 2024.

(51) Int. Cl. G06F 11/36

(52) U.S. Cl. CPC G06F 11/3608; G06F 11/3616

(57) ABSTRACT

A method for providing a testing and validation platform for machine learning lifecycle testing and validation includes analyzing a received dataset by conducting at least one statistical test of the dataset, the dataset comprising data representative of samples each comprising features and a corresponding target. Results of the analysis are displayed and a selected at least one feature of the features for training a machine learning model is received. Subsets of the dataset are validated, the subsets comprising an expert dataset, a training dataset, and a validation dataset and/or a test dataset, wherein each subset comprises data representative of distinct samples. The trained machine learning model is tested by using the expert dataset to determine at least one metric for each sample of the expert dataset and comparing each metric to a corresponding defined trust interval.

### PRIORITY CLAIM

This application claims the priority benefit of U.S. Provisional Patent Application Ser. No. 63/559,569, filed Feb. 29, 2024, the disclosure of which is incorporated herein by reference in its entirety.

### TECHNICAL FIELD

The subject matter described herein relates to machine learning model testing. More specifically, the subject matter relates to methods, systems, and computer readable media for providing a testing and validation platform for machine learning lifecycle testing and validation.

### BACKGROUND

As the use of artificial intelligence (AI), and especially machine learning, increases, the necessity of a continuous quality assurance by testing and documenting is needed. During a lifecycle of a product or solution containing a machine learning model (MLM), the MLM will be updated several times to adapt to changes within the solution's domain. All different models need to be tested and validated to ensure the requisite quality standards are met for each stage of the development cycle.

Methods for testing and validating MLMs do not provide a consistent set of tests for different stages of an MLM and thus cannot assure that each stage and aspect of the lifecycle is addressed accordingly. Each test is independent from the other tests and disconnected from different stages and iterations. Without a proper process and orchestration of tests, the time needed for development and the susceptibility to errors are increased.

Furthermore, a standardized and complete documentation cannot be ensured.

A deep knowledge of the domain and of machine learning (ML) is necessary to use the existing methodologies, challenging teams of domain experts and ML experts to find a common basis to address problems of both arenas. This increases the likelihood for errors and the requisite time to iterate the development of adapted models. There is a need for a continuous testing and validation of MLMs across all stages and several iterations from the initial planning of a MLM to the end of life of the solution by providing an iterative validation and testing process connecting all stages of the development cycle while being compatible with established software development processes like V-Model or Waterfall, independent from the domain.

### SUMMARY

Methods, systems, and computer readable media for providing a testing and validation platform for machine learning lifecycle testing and validation are disclosed. An example method for providing a testing and validation platform for machine learning lifecycle testing and validation includes analyzing, at the testing and validation platform, a received dataset by conducting at least one statistical test of the dataset, the dataset comprising data representative of samples each comprising features and a corresponding target. The method further includes displaying, by the testing and validation platform, results of the analysis. The method further includes receiving, at the testing and validation platform, a selected at least one feature of the features for training a machine learning model. The method further includes validating, by the testing and validation platform, subsets of the dataset, the subsets comprising an expert dataset, a training dataset, and a validation dataset and/or a test dataset, wherein each subset comprises data representative of distinct samples. The method further includes testing, by the testing and validation platform and after the machine learning model is trained, the machine learning model, by using the expert dataset to determine at least one metric for each sample of the expert dataset and comparing each metric of the at least one metric to a corresponding defined trust interval.

According to another aspect of the subject matter described herein, if the metrics determined from the expert dataset are within the corresponding defined trust interval, the method further includes testing, by the testing and validation platform, the machine learning model by determining at least one metric for each sample of the validation data set and/or the test dataset.

According to another aspect of the subject matter described herein, the method further includes comparing the metrics determined from the expert dataset with the metrics determined from the validation data set and/or the test dataset.

According to another aspect of the subject matter described herein, the method further includes defining clusters of the metrics determined from the expert data that determine cluster boundaries, defining clusters of the metrics determined from the validation data set and/or the test dataset, and comparing the clusters of the metrics determined from the expert dataset with the cluster boundaries.

According to another aspect of the subject matter described herein, the method further includes determining that the machine learning model is safe if the clusters of the metrics determined from the validation data set and/or the test dataset are inside the cluster boundaries.

According to another aspect of the subject matter described herein, the method further includes determining a score for the machine learning model based on the percentage of metrics determined from the validation data set and/or the test dataset that are inside the cluster boundaries.

According to another aspect of the subject matter described herein, the method further includes iteratively testing the machine learning model by determining metrics from the expert dataset, determining metrics from the validation data set and/or the test dataset, and comparing the metrics from the expert dataset with the metrics from the validation data set and/or the test dataset.

According to another aspect of the method described herein, results from each test of each machine model iteration are saved for comparison. According to another aspect of the method described herein, the at least one statistical test determines correlations between the features of the dataset and the displayed results include the determined correlations.

According to another aspect of the method described herein, the at least one statistical test identifies a degree of influence each of the features have on the at least one target and the displayed results include the features and the corresponding identified degrees of influence.

An example system for providing a testing and validation platform for machine learning lifecycle testing and validation includes a testing and validation platform configured for analyzing a received dataset by conducting at least one statistical test of the dataset, the dataset comprising data representative of samples each comprising features and a corresponding target. The system is further configured for displaying results of the analysis. The system is further configured for receiving a selected at least one feature of the features for training a machine learning model. The system is further configured for validating subsets of the dataset, the subsets comprising an expert dataset, a training dataset, and a validation dataset and/or a test dataset, wherein each subset comprises data representative of distinct samples. The system is further configured for testing the machine learning model and after the machine learning model is trained, by using the expert dataset to determine at least one metric for each sample of the expert dataset and comparing each metric of the at least one metric to a corresponding defined trust interval.

According to another aspect of the system described herein, the testing and validation platform is configured for, if the metrics determined from the expert dataset are within the corresponding defined trust interval, testing the machine learning model by determining at least one metric for each sample of the validation data set and/or the test dataset.

According to another aspect of the system described herein, the testing and validation platform configured for comparing the metrics determined from the expert dataset with the metrics determined from the validation data set and/or the test dataset.

The According to another aspect of the system described herein, the testing and validation platform is configured for defining clusters of the metrics determined from the expert data that determine cluster boundaries, defining clusters of the metrics determined from the validation data set and/or the test dataset, and comparing the clusters of the metrics determined from the expert dataset with the cluster boundaries.

According to another aspect of the system described herein, the testing and validation platform is configured for determining that the machine learning model is safe if the clusters of the metrics determined from the validation data set and/or the test dataset are inside the cluster boundaries.

According to another aspect of the system described herein, the testing and validation platform is configured for determining a score for the machine learning model based on the percentage of metrics determined from the validation data set and/or the test dataset that are inside the cluster boundaries.

According to another aspect of the system described herein, the testing and validation platform is configured for iteratively testing the machine learning model by determining metrics from the expert dataset, determining metrics from the validation data set and/or the test dataset, and comparing the metrics from the expert dataset with the metrics from the validation data set and/or the test dataset.

According to another aspect of the system described herein, the at least one statistical test identifies a degree of influence each of the features have on the at least one target and the displayed results include the features and the corresponding identified degrees of influence.

An example non-transitory computer readable medium has stored thereon executable instructions that when executed by at least one processor of at least one computer cause the at least one computer to perform steps including analyzing a received dataset by conducting at least one statistical test of the dataset, the dataset comprising data representative of samples each comprising features and a corresponding target. The non-transitory computer readable medium is further configured for displaying results of the analysis. The non-transitory computer readable medium is further configured for receiving a selected at least one feature of the features for training a machine learning model. The non-transitory computer readable medium is further configured for validating, by the testing and validation platform, subsets of the dataset, the subsets comprising an expert dataset, a training dataset, and a validation dataset and/or a test dataset, wherein each subset comprises data representative of distinct samples. The non-transitory computer readable medium is further configured for testing the machine learning model and after the machine learning model is trained, by using the expert dataset to determine at least one metric for each sample of the expert dataset and comparing each metric of the at least one metric to a corresponding defined trust interval.

According to another aspect of the non-transitory computer readable medium described herein, if the metrics determined from the expert dataset are within the corresponding defined trust interval, the non-transitory computer readable medium is further configured for testing the machine learning model by determining at least one metric for each sample of the validation data set and/or the test dataset.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram illustrating an example system for providing a testing and validation platform for machine learning lifecycle testing and validation;

FIG. 2 is a schematic diagram of five stages of testing and validation;

FIG. 3A shows an example display on a graphical user interface of a configuration for an ydata profile report generated by an open source ydata profiler;

FIG. 3B shows an example graphical user interface (GUI) display of an overview of an ydata profile report generated by an open source ydata profiler;

FIG. 4A shows an example GUI display of a report summary for a mutual information test;

FIG. 4B shows an example GUI display of a mutual information score chart;

FIG. 5 shows an example GUI display of a score analysis using metrics;

FIGS. 6A-6G collectively show an example JSON test result of a mutual information metric; and

FIG. 7 is a flow diagram illustrating an example method for providing a testing and validation platform for machine learning lifecycle testing and validation.

### DETAILED DESCRIPTION

The subject matter described herein includes methods, systems, and computer readable media for providing a testing and validation platform for machine learning lifecycle testing and validation. The testing and validation platform provides iterative testing through the entire lifecycle of the MLM, also referred to herein as the model. The lifecycle is divided into five stages, with each stage containing a set of tests to evaluate the datasets and model. The stages utilize metrics for analysis and interpretability by comparing results of the metrics to an expert dataset to determine the quality of the MLM. Results of tests, as well as recommendations to increase the performance of a given dataset or model are persisted together with the configuration of the tests, allowing an automation of these tests for later iterations of the five-stage process. The methodology allows an easy adaption of further tests, if the domain or the state-of-the-art calls for additional tests, enabling the orchestration of tests and validation for a plethora of different domains.

This standardized result schema allows an automated comparison between different models and thus speeds up the development process significantly. For example, if deployed in a continuous integration/continuous deployment (CI/CD) Pipeline, multiple different configurations of models could be trained and based on the automatically generated test results, only the best models could be used for the next stage, thus reducing the amount of manual testing, and validating. For example, it is possible to have an experienced ML expert set up the test_configuration for a ML project and thus enable domain experts to analyze the results provided by the tests with the help of easily understood visualizations and explanation texts.

The testing and validation platform creates a standardized way of testing and validating MLMs, which can be followed by AI and domain experts, building a common basis for domain and ML experts relying on statistics and easily understandable visualizations and thus ease the communication between the two groups, leading to faster and higher quality results. The testing and validation platform creates a common base for domain experts, who are knowledgeable in the domain/industry of the problem for which the MLM is being designed to solve, and AI experts, who are knowledgeable in AI development and implementing MLMs.

The testing and validation platform documents the test results, which provides a user with the possibility to rerun tests with the same configuration for a different model iteration. In an example deployed MLM for detecting pedestrians on crosswalks, a possible corner case can include a pedestrian pushing a bike. If the deployed MLM fails to detect this corner case, then the model must be updated to detect such corner cases. For this updated model, it is crucial to pass all quality tests. With the testing and validation platform, the engineer can rerun tests for all stages with the adopted datasets and models automatically, enabling a qualified comparison of MLMs and exporting results for documentation purpose.

The testing and validation platform can provide a checklist indicating which portions of the lifecycle and corresponding testing has been completed to confirm that all aspects of assurance and necessary tests are executed and documented. Using this methodology, it is possible to align the development and lifecycle of the model to issued governmental guidelines, like the EU AI Act and the US AI Bill of Rights and standards like DIN SPEC 13266.

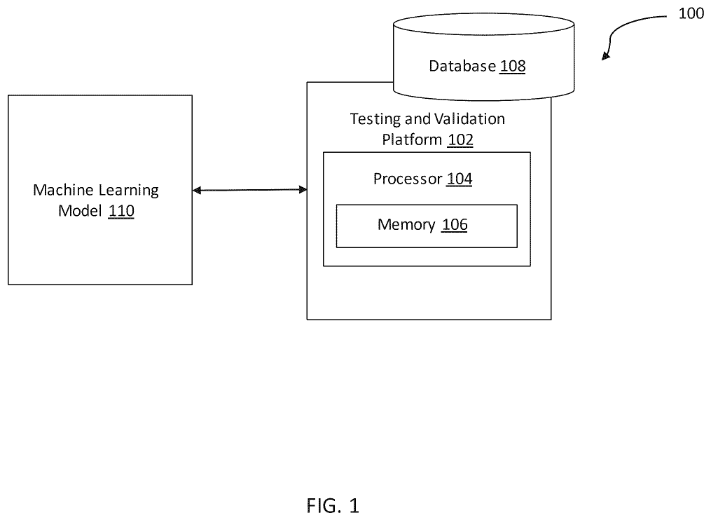

FIG. 1 is a block diagram illustrating an example system 100 for providing a testing and validation platform for machine learning lifecycle testing and validation. System 100 includes a testing and validation platform 102 with at least one processor 104 and memory 106. Testing and validation platform 102 may include, without limitation, a microcontroller, microprocessor, digital signal processor (DSP) and/or system on a chip (SoC) as described herein. Testing and validation platform 102 may include a single computing device operating independently, or may include two or more computing devices operating in concert, in parallel, sequentially or the like; two or more computing devices may be included together in a single computing device or in two or more computing devices. Testing and validation platform 102, using processor 104 and memory 106, may be configured to perform any of the steps described herein. Testing and validation platform 102 can include a database 108 from which the testing and validation platform 102 can store, access, edit, and retrieve information such as datasets and MLMs. Database 108 can include a cloud drive. Testing and validation platform 102 may communicate with a machine learning model 110, which may be stored locally, such as in memory 106 or database 108, or stored remotely, such as on one or more other computing devices with which the testing and validation platform 102 is configured to communicate.

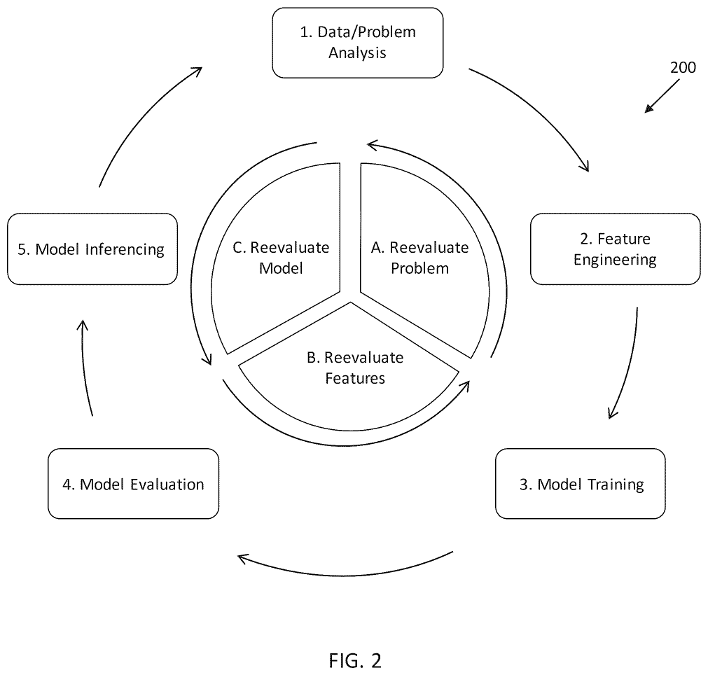

FIG. 2 shows a schematic diagram 200 of the five stages of testing and validation that testing and validation platform 102, shown in FIG. 1, performs iteratively throughout the lifecycle of the MLM. Testing and validation platform 102 can provide one or more tests for each stage. In one aspect of the described subject matter, testing and validation platform 102 can provide a preselected set of one or more tests for each stage and automatically execute the tests for the corresponding stage. In another aspect of the described subject matter, a user can select one or more tests within each stage and testing and validation platform 102 can automatically execute the selected tests. Testing and validation platform 102 can also upload specific tests for the domain in which the MLM is operating. Testing and validation platform 102 can further provide recommendations based on the test results as described herein. Testing and validation platform 102 can be configured to automatically proceed to the next stage once MLM passes one or more tests in a current stage. A passing score may be based on a user's instructions, industry standards, safety requirements, government guidelines, and the like. If in the following stage an issue arises, which cannot be fixed in the current stage, the user can easily return to the previous stage, adapt the dataset and model accordingly and rerun the tests of the stage to ensure that all required quality checks are still reached.

Stage 1 includes data and problem analysis. Users of testing and validation platform 102 can include AI experts and experts in the applicable field for which the MLM will be implemented, referred to herein as domain experts. Testing and validation platform 102 receives a dataset, which is used for training, testing, evaluating, and inferencing the MLM. The dataset includes data representative of samples, and each sample includes variables, namely features and a corresponding at least one target. For example, each sample in a dataset for a MLM designed for predicting the number of bicycles rented at a given hour from a bicycle rental shop, which is the target, may include as features the time of day, the weather, the day of the week, and whether the day is a federal holiday, and each sample may also identify a value for the corresponding target, which in this example is the number of bicycles rented within the corresponding hour. At Stage 1, testing and validation platform 102 assists AI experts and domain experts in conducting data analysis and problem analysis, respectively. Understanding the domain and the actual problem at hand is a crucial part of the machine learning. Domain experts are familiar with the domain and can provide insight to identify the object for the MLM, the target and potential features influencing the target, corner cases that the MLM must pass, and applicable safety standards. Without proper understanding of the data at hand, biases, and wrong presumptions can harmfully influence the further development of the MLM. Testing and validation platform 102 supports developers by automating the data analysis process and detecting biases and hidden correlation in the data, as well as providing a common basis for domain and ML experts relying on statistics and easily understandable visualizations.

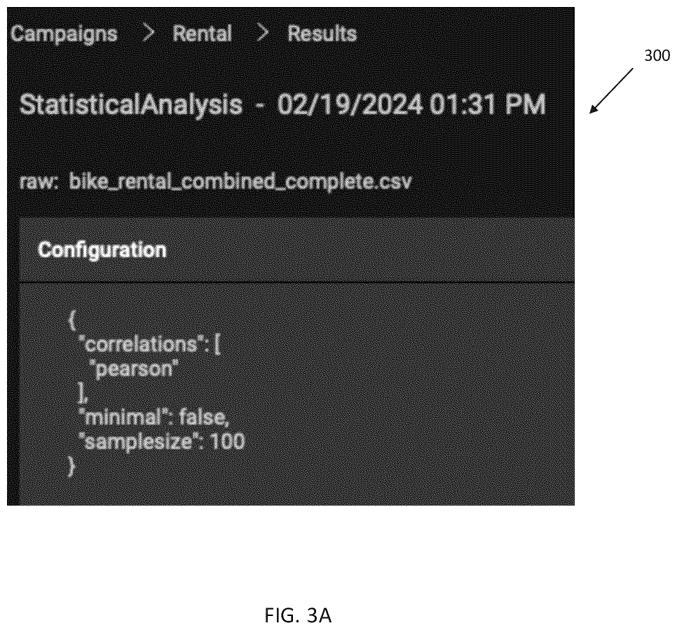

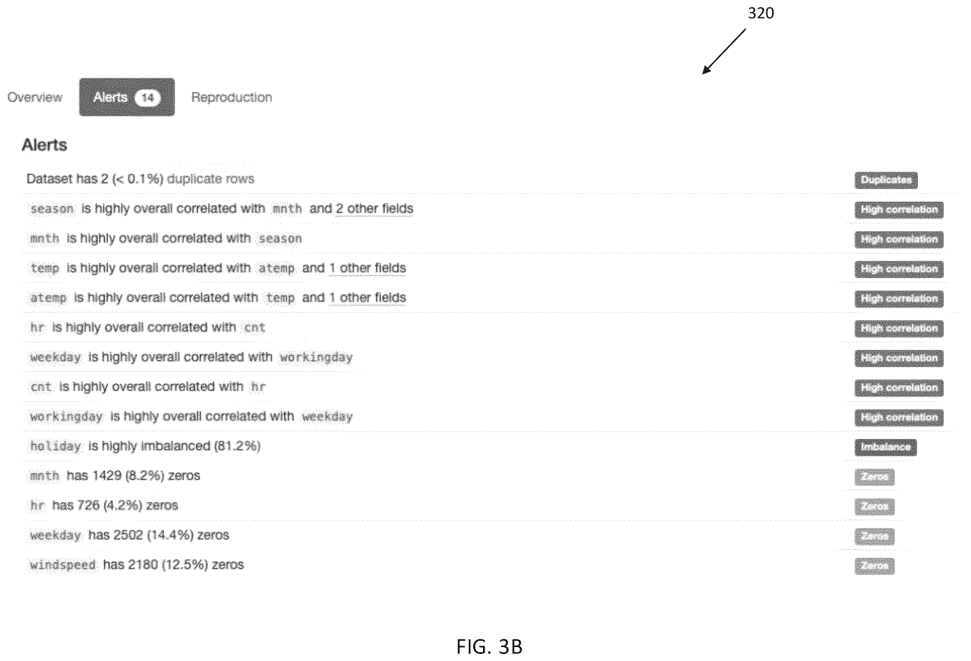

At stage 1, users evaluated the dataset, which can include determining if it contains sufficient data, how the data is scaled or which value ranges are at hand, if the dataset contains constant values, how the data is distributed, and the level of data quality. Testing and validation platform 102 provides one or more tests, which it can automatically run on the received dataset, and a resulting report to assist users with their analysis. The one or more tests can include third-party or open source tests, such as the ydata profiler that produces an ydata profile report, as shown in FIGS. 3A-3B. The ydata profile report can highlight important information, which allows users to quickly understand data characteristics. For example, the ydata profile report can identify duplicate rows of data in the dataset, a degree of correlation between variables such as between different features and between a feature and the target, and an imbalanced representation in a variable.

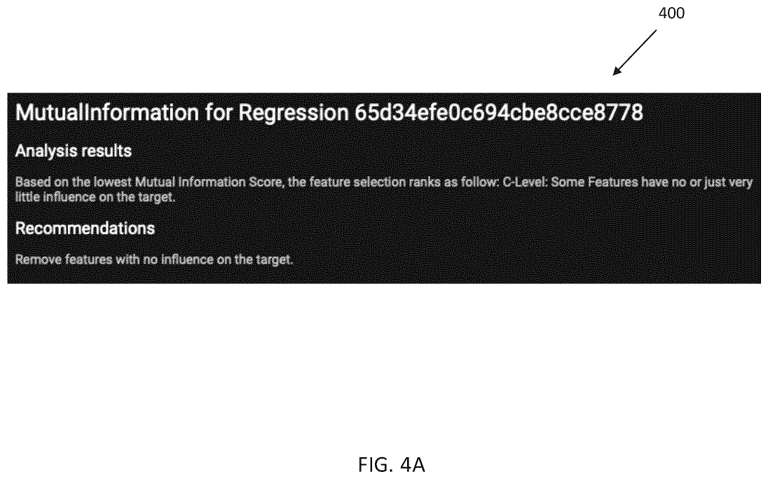

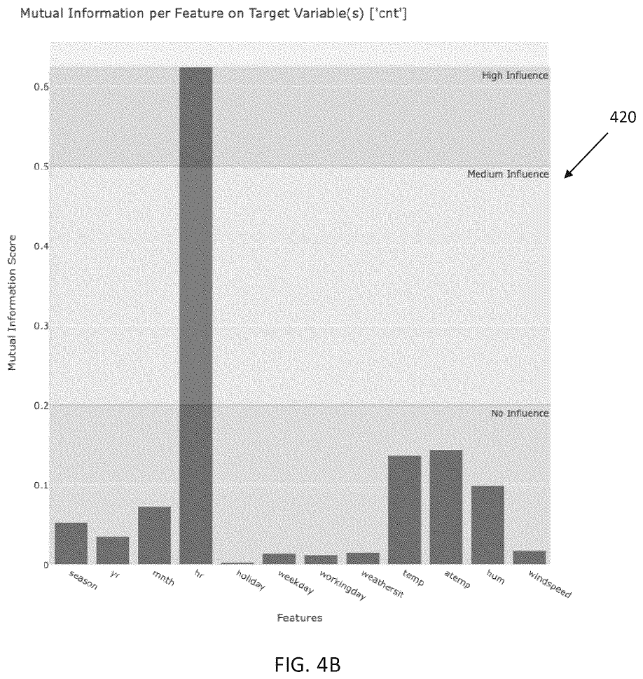

Stage 2 includes feature engineering. In stage 2, the features used for training are selected. Testing and validation platform 102 supports this decision by providing metrics to measure the influence of features on the target, measuring correlations and recommending which features should be used. Testing and validation platform 102 analyzes the received dataset by conducting at least one statistical test of the dataset. The statistical tests can determine correlations between the variables of the dataset, such as among features and/or between features and the at least one target. The statistical tests can determine mutual information of the features, which can include identifying a degree of influence each of the features have on the at least one target as shown in FIG. 4B. For example, testing and validation platform 102 can determine whether each feature has a high, medium, low, or no/negligible correlation to the at least one target. Based on the results, testing and validation platform 102 can provide a general recommendation for the users to removes the features with little or no information gain, such as the features that have little or no correlation with the target.

Testing and validation platform 102 displays results of the analysis, which can include the determined correlations among features and/or the at least one target. As an example, the results can include mutual information metrics. The displayed results can include the features and the corresponding identified degrees of influence. The results can be displayed in a chart showing the mutual information for each feature. Depending on the domain, there might be additional knowledge leading to a different feature importance, which can only be known by domain experts. The resulting plot is a foundation to discuss these problems and select the features most fitting for the problem. Testing and validation platform 102 supports users in their selection of one or more features having the highest importance, namely the highest correlations with the target. Testing and validation platform 102 receives a user selection of at least one feature.

For evaluating the MLM, data unknown to the model is needed. Testing and validation platform 102 helps users with the strict separation of datasets. A user can separate the dataset into distinct subsets, such as two, three, four, or more subsets of data. The subsets can include an expert dataset, a training dataset, a validation dataset, and/or a test dataset, wherein each subset comprises data representative of distinct samples. Testing and validation platform 102 validates the subsets of the dataset, the subsets comprising an expert dataset, a training dataset, and a validation dataset and/or a test dataset, wherein each subset comprises data representative of distinct samples. Validating the subsets can include identifying and flagging duplicative samples among the subsets of data, preventing faulty evaluation results caused by known data in the test set. Validating the subsets can also include ensuring that subsets of data, such as the training dataset, the validation dataset, and/or the test dataset, have similar distributions and no overlap. In this stage, users determine whether the subsets of data fulfill Operational Design Domain (ODD) requirements, cover corner cases in a sufficient form, and identify biases as well as hidden relations in the data.

The expert dataset is a subset of the received dataset that is selected and reviewed by domain experts for the representativeness of the domain and by AI experts for the fulfilling requirements for a dataset, such as a high accuracy and no biases. The expert dataset is a trusted interval in the results for each metric, such as a confidence interval, in which the results are deemed safe/accurate. The trust interval is a necessary condition for calculating a trust score. Testing and validation platform 102 can compare distributions and coverage of the dataset to assist the users in selecting the expert dataset, and testing and validation platform 102 receives the user's selection for the expert dataset. For the example of the bike rental dataset, a user may define that the Monte Carlo Dropout (MCD) error may not differ more than −0.15 and +0.6, while the Fast Gradient Sign Method (FGSM) may not differ more than −0.3 and +0.4 in comparison to the original data.

Stage 3 includes model training. In the third stage, testing and validation platform 102 supports the utilization of methods to analyze how well the model is adjusted to the problem, such as determining whether there is overfitting or underfitting and how vulnerable the model is against attacks. Based on the results, a recommendation for continuing, altering, or ending the training as well as options for improvement are provided. A user can either use the tests in this stage after a model was trained or utilize the tests during the validation phase of model training (e.g., after a set number of epochs), using the API of the testing and validation platform 102 to directly start tests from within the training setup. When training the MLM to fulfill a safety critical task, common metrics like accuracy, recall, and precision may not suffice to determine if the model has achieved the needed level of quality and reliability. Testing and validation platform 102 utilizes local (instance based) and global (general behavior of the model) interpretability metrics, as well as calibration checks to determine the maturity of the model and thus helps users to save costs by stopping the training at the right moment without sacrificing quality, as well as recommending actions to improve the predictions.

Stage 4 includes model evaluation. In this stage, testing and validation platform 102 performs an in-depth analysis of the model, utilizing the tests from the previous stage and more complex tests like local and global interpretability. Testing and validation platform 102 can provide standardized tests to determine the quality of the model. After the model is trained, testing and validation platform 102 tests the MLM by using the expert dataset to determine at least one metric for each sample of the expert dataset and comparing each metric of the at least one metric to a corresponding defined trust interval. The results are automatically persisted and can serve to compare different model iterations as well as proof that the evaluation was done to the highest standards and without negligence. A given configuration can be reused for a new iteration of testing and the results can be automatically compared. This leads to a significantly increased developmental speed if intergraded into an automatic CI/CD pipeline.

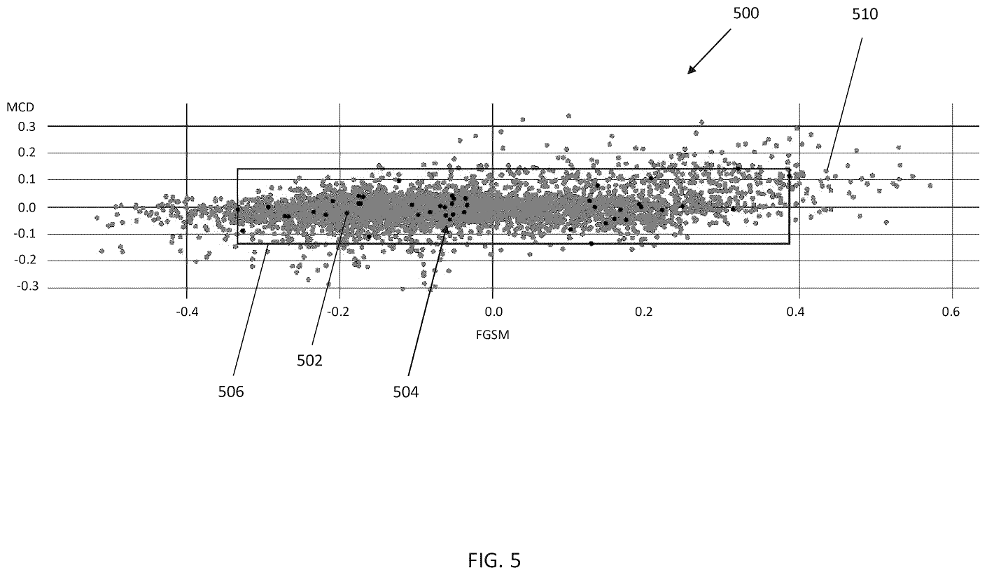

Testing and validation platform 102 computes the metrics with the MLM and the expert dataset. If the results are within the trust intervals for the corresponding metrics as determined by the users, testing and validation platform 102 can automatically continue testing. If the results are outside the trust interval, testing and validation platform 102 can stop further testing for model adjusting. The performance of the model with the expert dataset is the sufficient condition. If the results are in the expected range, tests with the validation dataset and/or test dataset can be performed in the later stages. Testing and validation platform 102 can define clusters of the metrics determined from the expert data, which determine cluster boundaries, as shown in FIG. 5. Using a density-based clustering algorithm like dbscan, testing and validation platform 102 can automatically define the cluster.

If the metrics determined from the expert dataset are within the corresponding defined trust interval, testing and validation platform 102 can test the MLM by determining at least one metric for each sample of the validation data set and/or the test dataset.

Testing and validation platform 102 can compare the metrics determined from the expert dataset with the metrics determined from the validation data set and/or the test dataset, as shown in FIG. 5. Testing and validation platform 102 can define clusters of the metrics determined from the validation dataset and/or the test dataset and compare these clusters with the clusters of metrics from the expert dataset and/or the cluster boundaries defined by the clusters of metrics from the expert dataset. Testing and validation platform 102 can determine that the machine learning model is safe if the clusters of the metrics determined from the validation data set and/or the test dataset are inside the cluster boundaries. Testing and validation platform 102 can determine a score for the machine learning model based on the percentage of metrics determined from the validation data set and/or the test dataset that are inside the cluster boundaries. In case of single outliers, an examination of those datapoints is recommended, and the score of the model is reduced by the percentage of datapoints outside the cluster boundaries. If the number of clusters that are found in the validation dataset and/or test dataset differs from the number of clusters in the expert dataset, testing and validation platform 102 determines that the model is not safe. Users can use the metrics from the validation dataset to tune hyperparameters and the metrics from the test dataset to ensure minimal overfitting of the model.

Based on all information from this and previous stages, testing and validation platform 102 can generate a recommendation that rates the model and provides insight into the maturity level, as well as production readiness. In this stage, testing and validation platform 102 can automatically compare models based on a set of different metrics, which can be preselected. This allows the user to train multiple models simultaneously, for example in different configurations or network sizes, and testing and validation platform 102 can automatically select the model with the highest scores for further evaluation or deployment.

Stage 5 includes model inferencing, where testing and validation platform 102 runs tests on collected real data to check for data and domain drift and recommend a retrain and adaption process if drift is detected. The real data can include live data and/or recorded live data, which can be added to testing and validation platform 102 in one or more batches. In this stage, testing and validation platform 102 can test the MLM in different scenarios to ensure the model is not overfitted to specific scenarios. For example, if the MLM trained to determine a safe braking distance using a dataset with features including weather, temperature, road conditions, and estimated size of vehicle ahead, but the future automobile manufacturing trend results in smaller and lighter compact cars with shorter braking distances, the trained MLM may not be equipped to accurately predict a safe braking distance in this new scenario. After a model is deployed, continuous observation of the model's behavior is necessary to ensure that the performance is not degraded by data or domain drift. In this stage, testing and validation platform 102 serves as a predictive maintenance to detect drift before the drift causes a substantial impact on the model's performance. Testing and validation platform 102 can automate iterative testing of the model and provide users with valuable insights into the inner workings of the models by recommending actions to further improve the predictions in the next iteration. Based on knowledge gained in the inference stage, testing and validation platform 102 can commence an iterative process of testing and validating the MLM, which with every iteration of the five stages improves the quality of the model continuously. Therefore, testing and validation platform 102 is configured to validate the model from the design phase of an ML project to the end of life of the product. FIG. 2 also shows the user's continual process of reevaluating the problem that the MLM is intended to address in Stage A, reevaluating the features, such as all identified features and/or the selected features and their correlation to the target in Stage B, and reevaluating the model in Stage C, all of which testing and validation platform 102 assists in as described herein. Testing and validation platform 102 can execute this evaluation in a stream process, using live data from production systems sent to a backend. The constant processing and analyzing of a stream of live data will allow the engineers to have a near real-time insight into the health of the model, utilizing a dashboard with the most important information, as well as an alert to unusual data and/or decisions. This insight will help engineers to speed up the continuous improvement process of their models and thus help to fulfil the requirement of updatable AI systems.

The five stages are iterative, meaning that after publishing a model, the improvement starts by reevaluating the dataset, closing the loop between step five and one. This iterative process is necessary to have an up-to-date model. After the first initial iteration of the stages, testing and validation platform 102 can execute the tests automatically, using the configurations saved alongside the test results from the initial iteration and thus enable an automated comparison and, if implemented on development side, an automated hyper parameter tuning as well. The proposed process reuses the configuration of metrics done in previous iterations by default, speeding up the development lifecycle and making different models comparable. The expert dataset might be updated between iterations, as new insights and corner cases are found in the Inference stage. Testing and validation platform 102 can iteratively test the MLM by determining metrics from the expert dataset, determining metrics from the validation data set and/or the test dataset, and comparing the metrics from the expert dataset with the metrics from the validation data set and/or the test dataset. Testing and validation platform 102 can save results from each test of each machine model iteration for comparison between different iterations of the same model and/or between iterations of different models if multiple models were trained.

In case of severe problems, the process allows for returning to the previous stage or iteration to correct the issues found in later stages, while maintaining a comprehensive documentation of changes by default. This enables the user to provide complete documentation to the official agencies to prove that there was no negligence and all risk minimizing steps were done. Each report can be exported and includes comprehensive information about the datasets used, the model used, execution time, metric configuration, and results to comply with government regulations.

The reports provided by testing and validation platform 102 include a textual description of the results and a visual representation, generally in the form of a graph, of the results. FIG. 3A shows an example display 300 on a graphical user interface of a configuration for an ydata profile report, which is generated by an open source ydata profiler. Display 300 includes a textual description of the results in the ydata profile report. FIG. 3B shows an example graphical user interface (GUI) display 320 of an overview of an ydata profile report. The overview includes a visual representation of the ydata profile report, which allows users to quickly understand characteristics of the variables in the ydata profile report, such as the level or degree that two variables are correlated and identified duplicates in the dataset.

FIG. 4A shows an example GUI display 400 of a report summary for a mutual information test, which includes an analysis of the results and recommendations, which in this example is to remove from the model the features with no influence on the target. FIG. 4B shows an example GUI display of a mutual information score chart, which includes a bar graph with features plotted on the x-axis and mutual information score plotted on the y-axis. Ranges of mutual information scores are identified as high influence, medium influence, and no influence, allowing users to readily understand the levels or degrees of influence the feature have on the at least one target. FIG. 5 shows an example GUI display 500 of a score analysis using metrics and generated by testing and validation platform. FIG. 5 includes metrics from the expert dataset and the test dataset, but it is understood that display 500 can include metrics from the validation dataset or another dataset. Metrics from the MCD test are plotted on the y-axis and metrics from the FGSM test are plotted on the x-axis. It is understood that different metrics from other statistical tests can be plotted in addition to or instead of the MCD and FGSM metrics. The metrics 502 of samples from the expert dataset are all close together forming one cluster 504 that define cluster boundaries 506, approximated by the rectangle shown in FIG. 5. Thus, the sufficient condition for calculating the score is met because the necessary condition of having metrics from the expert dataset be within selected trust intervals of [−0.15, +0.6] for MCD and [−0.3, +0.4] for FGSM is satisfied. However, not all metrics 510 of samples from the test dataset, which was not included in any of the training of the model and thus is unknown to it, are laying inside the defined cluster boundaries 506 of the rectangle. Testing and validation platform can determine a percentage of metrics 510 of samples from the test dataset within cluster boundaries 506, which is 93.47357065803668% in the example shown. As only about 93% of metrics 510 of samples from the test dataset are within cluster boundaries 506, testing and validation platform determines a score of about 93% for the combination of those two metrics. This system for evaluating a model's score can be used for different numbers of metrics, such as all metrics relevant for the model and problem at hand. The trust intervals defined by the experts for the expert dataset should be directly linkable to the level of safety criticality and “socially accepted risk.”

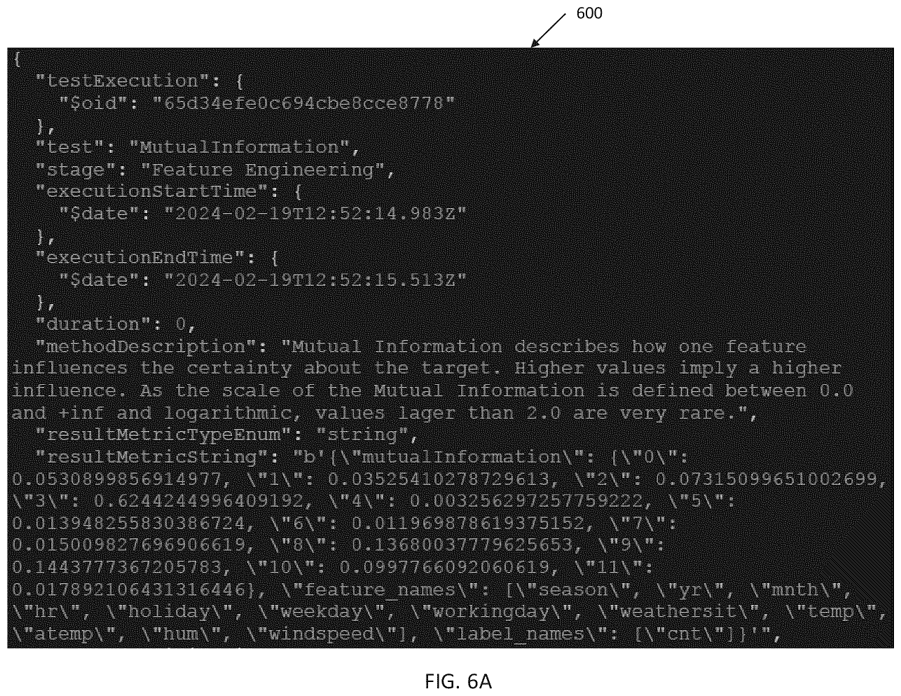

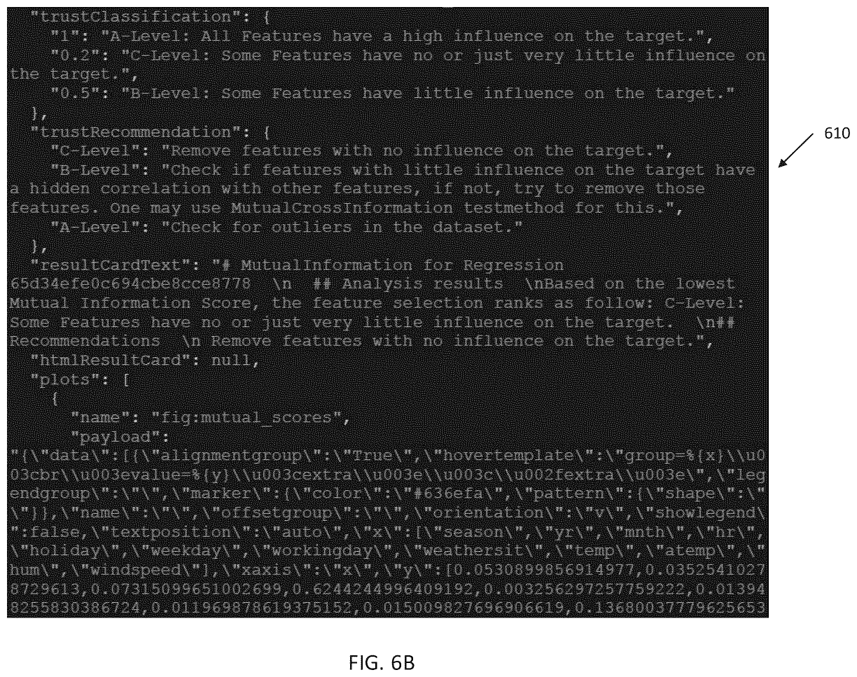

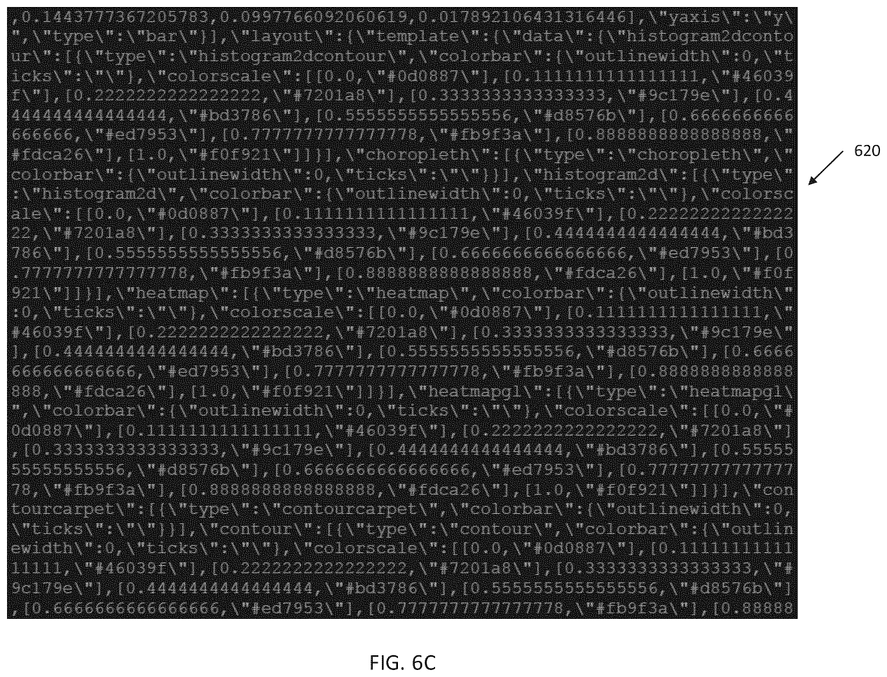

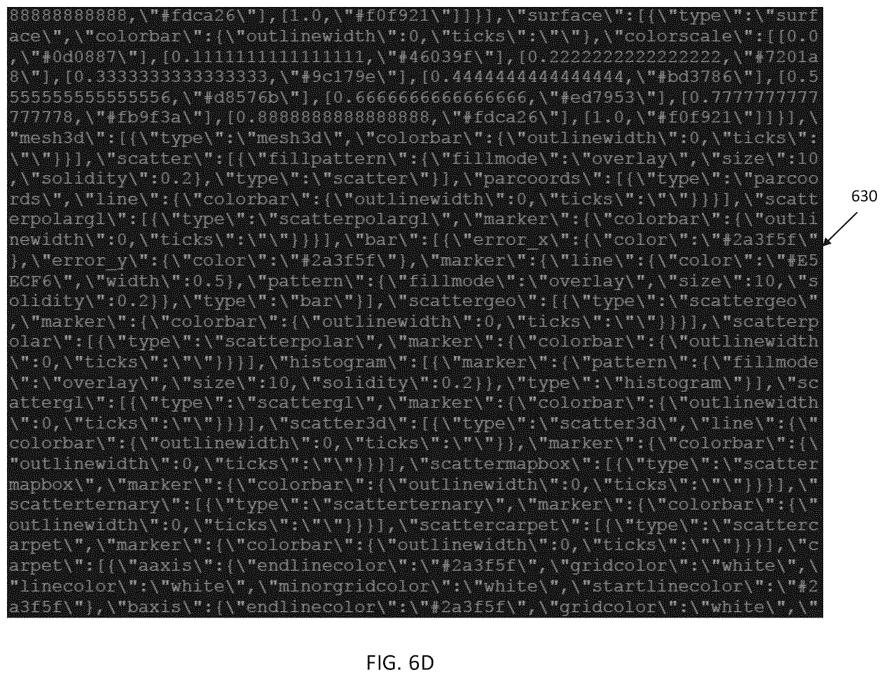

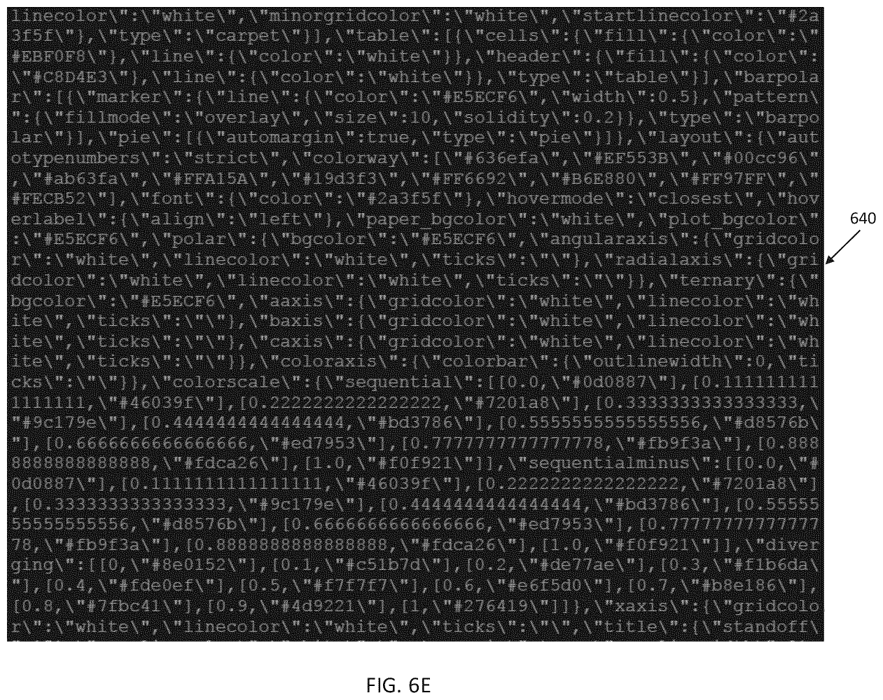

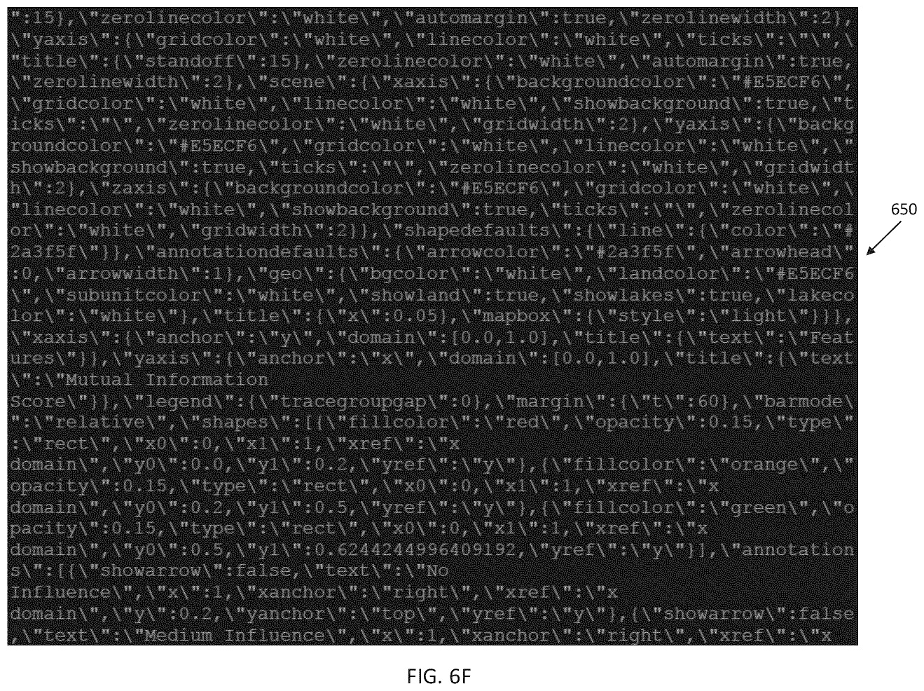

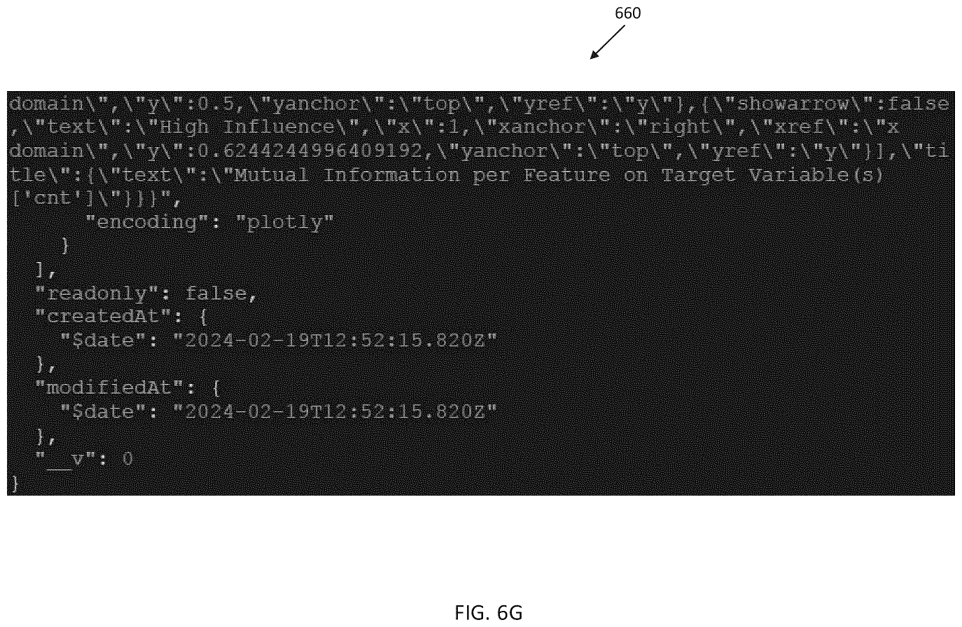

FIGS. 6A-6G collectively show an example JSON test result of a mutual information metric in displays 600, 610, 620, 630, 640, 650, and 660. This example test result includes a machine readable and comparable version of the test result. For an automated comparison, the value of the identifier “resultMetricString” is used, which stores the actual test results. Utilizing the underlying data structure, those automatic comparisons can be used to select the better fitting model and/or dataset, while ensuring that the same dataset was used for the tests.

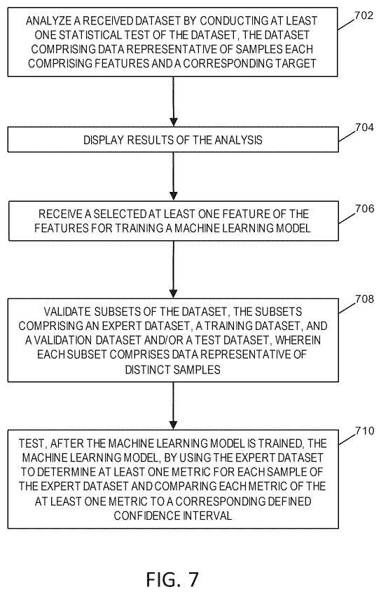

FIG. 7 is a flow diagram illustrating an example method 700 for providing a testing and validation platform for machine learning lifecycle testing and validation. At step 702, the testing and validation platform analyzes a received dataset by conducting at least one statistical test of the dataset, the dataset including data representative of samples each including features and a corresponding target.

At step 704, the testing and validation platform displays results of the analysis. The at least one statistical test can determine correlations between the features of the dataset and the displayed results can include the determined correlations. The at least one statistical test can identify a degree of influence each of the features have on the at least one target and the displayed results can include the features and the corresponding identified degrees of influence.

At step 706, the testing and validation platform receives a selected at least one feature of the features for training a machine learning model.

At step 708, the testing and validation platform validates subsets of the dataset, the subsets comprising an expert dataset, a training dataset, and a validation dataset and/or a test dataset, wherein each subset comprises data representative of distinct samples.

At step 710, after the machine learning model is trained, the testing and validation platform tests the machine learning model by using the expert dataset to determine at least one metric for each sample of the expert dataset and comparing each metric of the at least one metric to a corresponding defined trust interval.

If the metrics determined from the expert dataset are within the corresponding defined trust interval, the testing and validation platform can test the machine learning model by determining at least one metric for each sample of the validation data set and/or the test dataset. The testing and validation platform can compare the metrics determined from the expert dataset with the metrics determined from the validation data set and/or the test dataset. The testing and validation platform can define clusters of the metrics determined from the expert data, which determine cluster boundaries, and can define clusters of the metrics determined from the validation data set and/or the test dataset, and can compare the clusters of the metrics determined from the expert dataset with the cluster boundaries.

The testing and validation platform can determine that the machine learning model is safe if the clusters of the metrics determined from the validation data set and/or the test dataset are inside the cluster boundaries. The testing and validation platform can determine a score for the machine learning model based on the percentage of metrics determined from the validation data set and/or the test dataset that are inside the cluster boundaries. The testing and validation platform can iteratively test the machine learning model by determining metrics from the expert dataset, determining metrics from the validation data set and/or the test dataset, and comparing the metrics from the expert dataset with the metrics from the validation data set and/or the test dataset. Results from each test of each machine model iteration can be saved for comparison.

It will be appreciated that method 700 is for illustrative purposes and that different and/or additional actions may be used. It will also be appreciated that various actions described herein may occur in a different order or sequence. It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing a testing and validation platform for machine learning lifecycle testing and validation, the method comprising:
analyzing, at the testing and validation platform, a received dataset by conducting at least one statistical test of the dataset, the dataset comprising data representative of samples each comprising features and a corresponding target;
displaying, by the testing and validation platform, results of the analysis;
receiving, at the testing and validation platform, a selected at least one feature of the features for training a machine learning model;
validating, by the testing and validation platform, subsets of the dataset, the subsets comprising an expert dataset, a training dataset, and a validation dataset and/or a test dataset, wherein each subset comprises data representative of distinct samples; and
testing, by the testing and validation platform and after the machine learning model is trained, the machine learning model, by using the expert dataset to determine at least one metric for each sample of the expert dataset and comparing each metric of the at least one metric to a corresponding defined trust interval.

2. The method of claim 1 comprising, if the metrics determined from the expert dataset are within the corresponding defined trust interval, testing, by the testing and validation platform, the machine learning model by determining at least one metric for each sample of the validation data set and/or the test dataset.

3. The method of claim 2 comprising comparing the metrics determined from the expert dataset with the metrics determined from the validation data set and/or the test dataset.

4. The method of claim 3 comprising defining clusters of the metrics determined from the expert data that determine cluster boundaries, defining clusters of the metrics determined from the validation data set and/or the test dataset, and comparing the clusters of the metrics determined from the expert dataset with the cluster boundaries.

5. The method of claim 4 comprising determining that the machine learning model is safe if the clusters of the metrics determined from the validation data set and/or the test dataset are inside the cluster boundaries.

6. The method of claim 4 comprising determining a score for the machine learning model based on the percentage of metrics determined from the validation data set and/or the test dataset that are inside the cluster boundaries.

7. The method of claim 3 comprising iteratively testing the machine learning model by determining metrics from the expert dataset, determining metrics from the validation data set and/or the test dataset, and comparing the metrics from the expert dataset with the metrics from the validation data set and/or the test dataset.

8. The method of claim 7 wherein results from each test of each machine model iteration are saved for comparison.

9. The method of claim 1 wherein the at least one statistical test determines correlations between the features of the dataset and the displayed results include the determined correlations.

10. The method of claim 1 wherein the at least one statistical test identifies a degree of influence each of the features have on the at least one target and the displayed results include the features and the corresponding identified degrees of influence.

11. A system for providing a testing and validation platform for machine learning lifecycle testing and validation, the system comprising:
a testing and validation platform configured for:
analyzing a received dataset by conducting at least one statistical test of the dataset, the dataset comprising data representative of samples each comprising features and a corresponding target;
displaying results of the analysis;
receiving a selected at least one feature of the features for training a machine learning model;
validating subsets of the dataset, the subsets comprising an expert dataset, a training dataset, and a validation dataset and/or a test dataset, wherein each subset comprises data representative of distinct samples; and
testing the machine learning model and after the machine learning model is trained, by using the expert dataset to determine at least one metric for each sample of the expert dataset and comparing each metric of the at least one metric to a corresponding defined trust interval.

12. The system of claim 11 wherein the testing and validation platform is configured for, if the metrics determined from the expert dataset are within the corresponding defined trust interval, testing the machine learning model by determining at least one metric for each sample of the validation data set and/or the test dataset.

13. The system of claim 12 wherein the testing and validation platform configured for comparing the metrics determined from the expert dataset with the metrics determined from the validation data set and/or the test dataset.

14. The system of claim 13 wherein the testing and validation platform is configured for defining clusters of the metrics determined from the expert data that determine cluster boundaries, defining clusters of the metrics determined from the validation data set and/or the test dataset, and comparing the clusters of the metrics determined from the expert dataset with the cluster boundaries.

15. The system of claim 14 wherein the testing and validation platform is configured for determining that the machine learning model is safe if the clusters of the metrics determined from the validation data set and/or the test dataset are inside the cluster boundaries.

16. The system of claim 14 wherein the testing and validation platform is configured for determining a score for the machine learning model based on the percentage of metrics determined from the validation data set and/or the test dataset that are inside the cluster boundaries.

17. The system of claim 13 wherein the testing and validation platform is configured for iteratively testing the machine learning model by determining metrics from the expert dataset, determining metrics from the validation data set and/or the test dataset, and comparing the metrics from the expert dataset with the metrics from the validation data set and/or the test dataset.

18. The system of claim 10 wherein the at least one statistical test identifies a degree of influence each of the features have on the at least one target and the displayed results include the features and the corresponding identified degrees of influence.

19. A non-transitory computer readable medium having stored thereon executable instructions that when executed by at least one processor of at least one computer cause the at least one computer to perform steps comprising:
analyzing a received dataset by conducting at least one statistical test of the dataset, the dataset comprising data representative of samples each comprising features and a corresponding target;
displaying results of the analysis;
receiving a selected at least one feature of the features for training a machine learning model;
validating, by the testing and validation platform, subsets of the dataset, the subsets comprising an expert dataset, a training dataset, and a validation dataset and/or a test dataset, wherein each subset comprises data representative of distinct samples; and
testing the machine learning model and after the machine learning model is trained, by using the expert dataset to determine at least one metric for each sample of the expert dataset and comparing each metric of the at least one metric to a corresponding defined trust interval.

20. The non-transitory computer readable medium of claim 19 wherein if the metrics determined from the expert dataset are within the corresponding defined trust interval, testing the machine learning model by determining at least one metric for each sample of the validation data set and/or the test dataset.
